(19) United States
(12) Patent Application Publication
(10) Pub. No.: US 2017/0192269 A1
(43) Pub. Date: Jul. 6, 2017

(54) Sealant Coating Apparatus and Sealant Coating Method

(71) Applicants: BOE Technology Group Co., Ltd., Beijing (CN); HEFEI Xinsheng Optoelectronics Technology Co., Ltd, Hefei City (CN)

(72) Inventors: Jian Ma, Beijing (CN); Kai Wang, Beijing (CN)

(21) Appl. No.: 15/263,652

(22) Filed: Sep. 13, 2016

(30) Foreign Application Priority Data
Jan. 4, 2016 (CN) 201610006868.1

(51) Int. Cl. G02F 1/1339; B05D 3/06; G02F 1/13

(52) U.S. Cl. CPC G02F 1/1339; G02F 1/1303; B05D 3/067

(57) ABSTRACT

A sealant coating apparatus and a sealant coating method are provided. The sealant coating apparatus includes a sealant injection head and an ultraviolet lamp. The ultraviolet lamp is at least disposed at a side of the sealant injection head. Upon sealant being coated on a substrate with the sealant injection head, the ultraviolet lamp is configured to pre-cure an inner side of the sealant. The sealant coating apparatus and the sealant coating method can be used in a sealant coating process.

This application claims priority to and the benefit of Chinese Patent Application No. 201610006868.1 filed on Jan. 4, 2016, which application is incorporated herein in its entirety.

### TECHNICAL FIELD

Embodiments of the present invention relate to a sealant coating apparatus and a sealant coating method.

### BACKGROUND

With the development of liquid display technology, thin film transistor liquid crystal displays (TFT-LCDs) have been a mainstream of the market because of high quality, low consumption, and being free of radiation. A TFT-LCD includes an array substrate and a color filter substrate that are opposite to each other, and liquid crystals filled between the array substrate and the color filter substrate. For example, in the manufacturing process, after liquid crystals are dropped on the array substrate and/or color substrate, sealant is coated on the array substrate and/or color substrate, and the array substrate and color filter substrate are cell-assembled.

### SUMMARY

At least one embodiment of the invention provides a sealant coating apparatus and a sealant coating method, problems that sealant is dissolved in liquid crystals and contamination arises can be avoided, therefore, a yield rate of products can be improved.

At least one embodiment of the invention provides a sealant coating apparatus comprising a sealant injection head and an ultraviolet lamp, wherein the ultraviolet lamp is at least disposed at a side of the sealant injection head, upon sealant being coated on a substrate with the sealant injection head, the ultraviolet lamp is configured to pre-cure an inner side of the sealant.

At least one embodiment of the invention further provides a sealant coating method comprising: coating sealant on a substrate with a sealant injection head; and upon the sealant being coated on the substrate, pre-curing an inner side of the sealant with an ultraviolet lamp.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1a is a schematic view of a sealant coating apparatus provided by an embodiment of the invention;

FIG. 1b is a schematic coating effect view of sealant coated on a substrate using a sealant coating apparatus provided by an embodiment of the invention;

FIG. 2 is a side schematic view of a LED ultraviolet lamp provided by an embodiment of the invention;

FIG. 3 is a top schematic view of a LED ultraviolet lamp provided by an embodiment of the invention;

FIG. 4a is a top schematic view of a sealant coating apparatus provided by an embodiment of the invention;

FIG. 4b is a top schematic view of another sealant coating apparatus provided by an embodiment of the invention;

FIG. 5 is a flow chart of a sealant coating method provided by an embodiment of the invention.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

After cell-assembling an array substrate and a color substrate, sealant needs to be subject to an ultraviolet curing process and a thermocuring process sequentially, in order to generate a cross linkage reaction in the sealant under the catalysis of UV light firstly to form a macromolecule compound, and then in the subsequent thermocuring process, by continuing reaction the sealant is cured completely to bond the array substrate and the color substrate. After the array substrate and the color substrate are cell-assembled and before the ultraviolet curing process is completed, the sealant has a certain fluid property because the sealant is composed of small molecules, and is easy to contact liquid crystals to arise dissolution contamination. Therefore, after the array substrate and the color substrate are cell-assembled and before the ultraviolet curing process is completed, the diffused liquid crystals are contacted with the uncured sealant, which results in that the component of the sealant is dissolved and contaminates the liquid crystals. Therefore, defections such as image retention or light leakage arise when a liquid crystal panel displays images.

To address the above-mentioned problems, methods such as increasing a distance of a liquid crystal coated pattern and the sealant is used. However, in a case that the distance is too large, liquid crystals are hard to diffuse to the periphery, and then new problems such as incompletely filling and corner bubbles arise in the periphery, which leads to a yield loss of products. Therefore, after the array substrate and the color substrate are cell-assembled and before the ultraviolet curing process is completed, it is important to effectively avoid contamination to liquid crystals generated by dissolving the sealant to the liquid crystals.

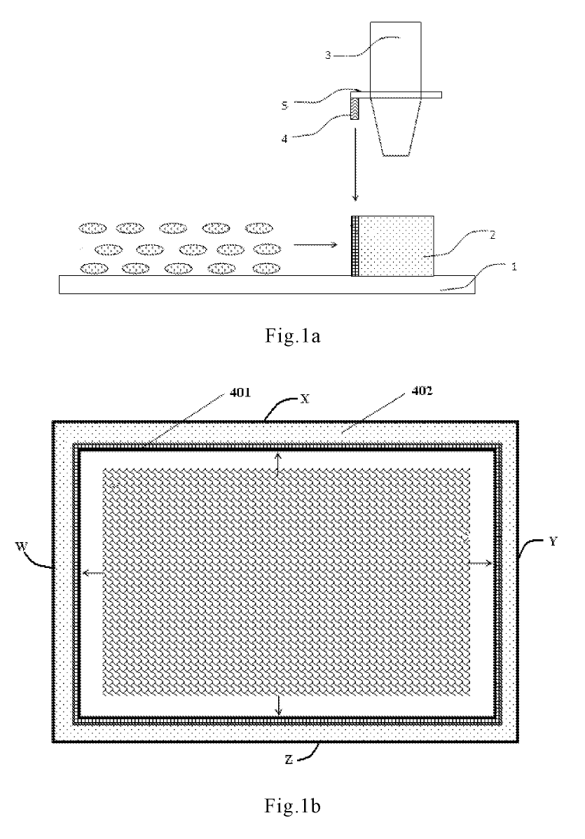

FIG. 1a is a schematic view of a sealant coating apparatus provided by an embodiment of the invention. As illustrated in FIG. 1a, the sealant coating apparatus, provided by the embodiment of the invention, includes a sealant injection head 3 and an ultraviolet lamp 4. The ultraviolet lamp 4 is at least disposed at a side of the sealant injection head 3. Upon sealant 2 being coated on a substrate 1 with the sealant injection head 3, the ultraviolet lamp 4 is configured to pre-cure an inner side of the sealant 2. For example, the inner side of the sealant is a side of the sealant close to a centre of the substrate.

In the embodiment, upon coating sealant being coated on the substrate with the sealant injection head, the ultraviolet lamp is configured to pre-cure the inner side of the sealant, which means that the inner side of the sealant is irradiated by ultraviolet light emitted by the ultraviolet lamp, the inner side of the sealant is pre-cured to form a macromolecule structure in a short time, and contamination to liquid crystals are avoided when the sealant is contacted with the diffused liquid crystals. For example, the inner side of the sealant is a portion of the sealant surrounding the liquid crystal coated pattern and close to an outer edge of the liquid crystal coated pattern. FIG. 1b illustrates the inner side 401 of the sealant. For example, the sealant 2 coated on the substrate forms an annular sealant. The inner side of the sealant means that a portion which is located at the inner side of the annular sealant. For example, annular includes rectangular or circular, but is not limited thereto.

In the embodiment, as illustrated in FIG. 1a, the ultraviolet lamp is at least disposed at a side of the sealant injection head, which means that when the sealant injection head is coating, the ultraviolet lamp is disposed above the sealant and at a side of the sealant close to liquid crystals. The relative position of the ultraviolet lamp and the sealant injection head are not limited thereto, as long as the ultraviolet lamp is capable of radiating and pre-curing an inner side of the sealant upon sealant being coated on a substrate. Moreover, the ultraviolet lamps can be fixed on four sides of a rectangular frame-like lamp hanger, in this way, when the sealant injection head moves to any side of the rectangular frame-like lamp hanger, the ultraviolet lamp fixed on the side is turned on. The method of the ultraviolet lamp disposing on four sides of the rectangular frame-like lamp hanger will be illustrated fully in the following.

The sealant coating apparatus provided by embodiments of the invention, by providing an ultraviolet lamp at a side of the sealant injection head, upon sealant being coated on a substrate with the sealant injection head, an inner side of the sealant is irradiated by ultraviolet light emitted by the ultraviolet lamp and is cured. Therefore, after the array substrate and the color substrate are cell-assembled and before ultraviolet curing is completed, because the inner side of the sealant have been subject to an ultraviolet curing process, small molecules in the sealant have been cross linked to form a macromolecule structure, and macromolecules are hard to be dissolved to contaminate the liquid crystals. Therefore, the yield rate of products can be improved, and defections such as image retention or light leakage when a liquid crystal panel displays images can be avoided. Moreover, because the inner side of the sealant has been subject to a pre-curing process in cell-assembling, the liquid crystals will not be contaminated even if liquid crystals which are diffused are contacted with the sealant. Therefore, a distance between an edge of the liquid crystal coated pattern and the sealant can be decreased to let liquid crystals be fully diffused, defections such as incompletely filling and corner bubbles can be reduced.

In the above-mentioned embodiments, the ultraviolet lamp includes a light emitting diode (LED) ultraviolet lamp, but is not limited thereto. The ultraviolet lamp can be a strip-like ultraviolet lamp, and a long axis direction of the strip-like ultraviolet lamp is perpendicular to a main surface of the substrate. By selecting a strip-like ultraviolet lamp, and arranging the strip-like ultraviolet as the above-mentioned way, a radiation area and a radiation amount at the inner side of the sealant can be effectively increased, and the inner side of the sealant can be pre-cured rapidly.

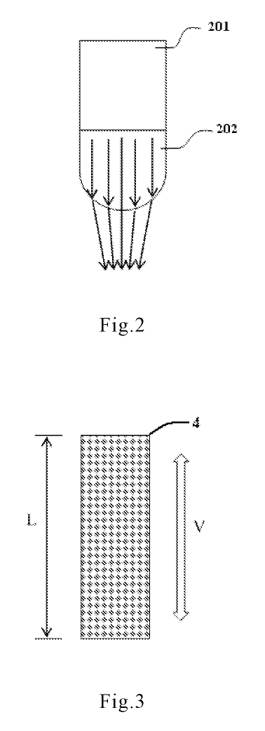

For example, in an embodiment, the ultraviolet lamp 4 can include a convex lampshade. As illustrated in FIG. 2, the ultraviolet lamp 4 can include an ultraviolet lamp body 201 and a convex lampshade 202. The convex lampshade 202 can use a converging principle to increase radiation accuracy, a local light strength increases after light is enhanced, curing efficiency can be improved significantly. Usually, when the sealant is subject to an ultraviolet curing process, an ultraviolet radiation amount needed to be irradiated on the sealant is about 2000-8000 mJ. Therefore, the power of the ultraviolet lamp can be about 2000-8000 mJ. An ultraviolet lamp can be selected according to the following parameters: power W×L÷V=2000-8000 mJ, wherein W is a power of an ultraviolet lamp, “L±V” is a time that a unit area of the inner side of the sealant subject to be irradiate in a coating process, L is a length of an ultraviolet lamp, V is a coating speed rate of sealant. As illustrated in FIG. 3, the embodiment takes a strip-like ultraviolet lamp as an example to illustrate. For example, L is a length of an ultraviolet lamp along a traveling direction of the sealant injection head.

In order to make the inner side of the sealant coated on the substrate can be pre-cured sequentially and continuously, the ultraviolet lamp 4 can be disposed at a side of the sealant injection head by a rectangular frame-like lamp hanger. The rectangular frame-like lamp hanger is selected because a shape of the substrate is usually rectangular, the sealant coated on four sides of the substrate can be subject to a pre-curing process sequentially and continuously. The shape of the lamp hanger is not limited thereto, and can be designed according to needs such as process, shape of a substrate to be coated, position and space.

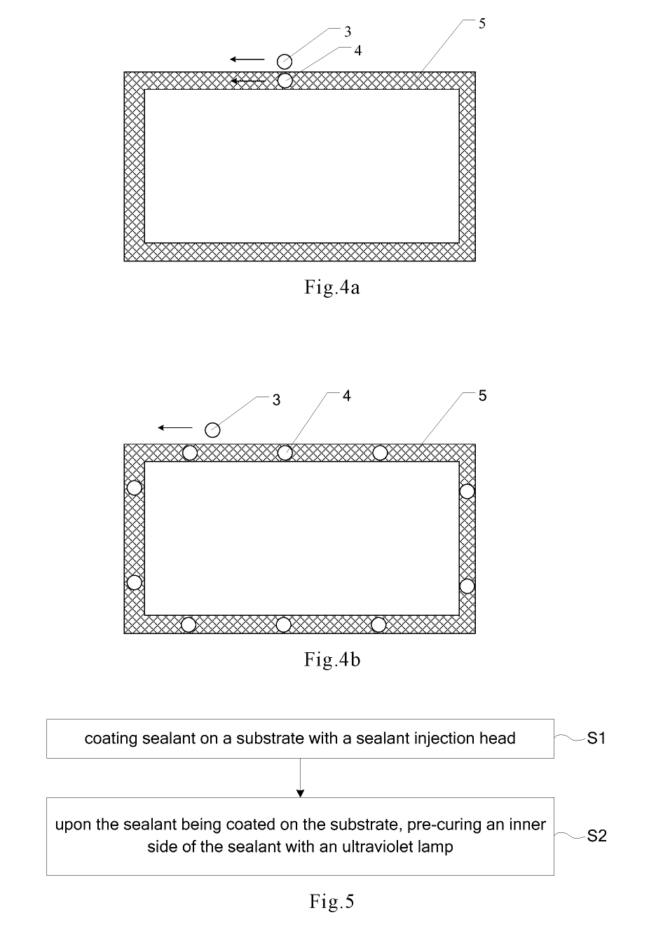

There are various ways to provide the ultraviolet lamp 4 on the rectangular frame-like lamp hanger 5. For example, as illustrated in FIG. 4a, a movable ultraviolet lamp 4 is disposed at any side of the rectangular frame-like lamp hanger 5. Or as illustrated in FIG. 4b, at least one ultraviolet lamp 4 which is immovable is disposed at each side of the rectangular frame-like lamp hanger 5. Therefore, according to various process needs, many ways to pre-cure the sealant by the ultraviolet lamp can be selected to make the inner side of the sealant be completely pre-cured. It is to be understood that, the setting ways that the ultraviolet lamp 4 is disposed on the rectangular frame-like lamp hanger 5 are not limited as mentioned above, and the skilled in the art can adopt other ways.

As illustrated in FIG. 5, at least one embodiment of the present invention provides a sealant coating method including the following steps.

S1: sealant is coated on a substrate with a sealant injection head.

S2: upon the sealant being coated on the substrate, an inner side of the sealant is pre-cured with an ultraviolet lamp.

The sealant coating method provided by the embodiment, upon the sealant being coated on the substrate with a sealant injection head, an inner side of the sealant is irradiated by ultraviolet light emitted by the ultraviolet lamp, the inner side of the sealant is pre-cured to form a macromolecule structure in a short time, to avoid contaminating liquid crystals when the sealant is contacted with liquid crystals which are diffused after an array substrate and a color substrate are cell-assembled and before an ultraviolet curing is completed. For example, the sealant coated on each side of the substrate is coated at one time, and coating amount can be adjusted according to the process to meet the needs of the process.

The sealant coating method provided by the embodiment of the present invention, upon sealant being coated on a substrate, an inner side of the sealant is irradiated by ultraviolet light emitted by the ultraviolet lamp and is pre-cured. Therefore, after an array substrate and a color substrate are cell-assembled and before an ultraviolet curing is completed, because the inner side of the sealant has been subject to being pre-cured and cross linked to form macromolecule structure, and the macromolecules are hard to be dissolved to contaminate the liquid crystals, the yield rate of products can be improved. At the same time, because the inner side of the sealant has been pre-cured before cell-assembling, a distance between an edge of a liquid crystal coated pattern and the sealant can be decreased. Therefore, the liquid crystals can be fully diffused. Defections such as incompletely filling and corner bubbles can be avoided. The methods provided by the embodiments are simple and highly practical.

In an embodiment, the inner side of the sealant is 10%-20% of a total volume of the sealant. Setting the proportion of the inner side of the sealant in the above-mentioned range, not only the inner side of the sealant can be pre-cured, and not contaminate the liquid crystals, but also an influence on after-bonding property of the substrates can be avoided.

In an embodiment, the ultraviolet lamp is disposed at a side of the sealant injection head by a rectangular frame-like lamp hanger to pre-cure the inner side of the sealant. The reason for providing the ultraviolet lamp on the rectangular frame-like lamp hanger is the shape of the rectangular frame-like lamp hanger matches the shape of the substrate which is usually used in the process. Therefore, the need to pre-cure the sealant at four sides of the substrate sequentially and continuously can be met.

In the above-mentioned embodiments, there are many ways to provide the ultraviolet lamp on a side of the sealant injection head by the rectangular frame-like lamp hanger, and different ways to pre-cure the inner side of the sealant can be adopted. For example, in a case that an ultraviolet lamp which is capable of moving is disposed at any side of the rectangular frame-like lamp hanger, and the ultraviolet lamp is capable of moving with the sealant injection head, therefore, the inner side of the sealant can be pre-cured sequentially with the moving of the ultraviolet lamp. That is, in a case that the sealant injection head moves clockwise during coating, the ultraviolet lamp moves clockwise with the sealant injection head, while in a case that the sealant injection head moves counter clockwise during coating, the ultraviolet lamp moves counter clockwise with the sealant injection head, in order to pre-cure the inner side of the sealant. Moreover, at least one ultraviolet lamp can be fixed at each side of the rectangular frame-like lamp hanger, and when the sealant injection head moves to any side of the rectangular frame-like lamp hanger, the ultraviolet lamp fixed on the side is turned on. Therefore the aim to pre-cure the inner side of the sealant can be realized. That is, as illustrated in FIG. 1b, when the sealant injection head moves from X side, the ultraviolet lamp on the X side is turned on, when the sealant injection head moves from X side to Y side, the ultraviolet lamp on the X side is turned off, and the ultraviolet lamp on the Y side is turned on, and so on till the Z side and W side are irradiated. And the pre-curing to the inner side of the sealant can be realized.

The following embodiments are provided to fully and clearly illustrate the sealant coating apparatus and the sealant coating method.

### First Embodiment

As illustrated in FIG. 1a, when sealant 2 is coated on a substrate, a sealant injection head 3 is used to coat the sealant on a substrate. An ultraviolet lamp 4 is disposed on a side of the sealant injection head 3. Upon sealant 2 being coated on the substrate by using the sealant injection head 3, an inner side of the sealant, which is 10% of a total volume of the sealant, is irradiated by the ultraviolet light emitted by the ultraviolet lamp 4, and is pre-cured.

### Second Embodiment

As illustrated in FIG. 1a, when sealant 2 is coated on a substrate, a sealant injection head 3 is used to coat the sealant on a substrate. An ultraviolet lamp 4 is disposed on a side of the sealant injection head 3. Upon sealant 2 being coated on the substrate by using the sealant injection head 3, an inner side of the sealant, which is 15% of a total volume of the sealant, is irradiated by the ultraviolet light emitted by the ultraviolet lamp 4, and is pre-cured.

### Third Embodiment

As illustrated in FIG. 1a, when sealant 2 is coated on a substrate, a sealant injection head 3 is used to coat the sealant on a substrate. An ultraviolet lamp 4 is disposed on a side of the sealant injection head 3. Upon sealant 2 being coated on the substrate by using the sealant injection head 3, an inner side of the sealant, which is 20% of a total volume of the sealant, is irradiated by the ultraviolet light emitted by the ultraviolet lamp 4, and is pre-cured.

Taking the first embodiment as an example, the coating effect after the inner side of the sealant which is coated on the substrate and irradiated by the ultraviolet is observed. As illustrated in FIG. 1b, the inner side 401 of the sealant (about in the range of 10%-20%) has been pre-cured by radiation of the ultraviolet lamp. Because the inner side of the sealant has been cross linked to form macromolecule structure by an ultraviolet pre-curing process, after the substrate with the sealant formed thereon and another substrate are cell-assembled, the inner side of the sealant is hard to be dissolved in liquid crystals when the inner side of the sealant is contacted with liquid crystals. Moreover, as illustrated in FIG. 1b, because the inner side of the sealant has been crossed linked, a distance between an edge of a liquid crystal coated pattern and the sealant is decreased greatly, and liquid crystals can be fully diffused, therefore, defections such as incompletely filling and corner bubbles are reduced.

The sealant coating apparatus and the sealant coating method provided by embodiments of the invention, upon sealant being coated on a substrate, an inner side of the sealant is irradiated by ultraviolet light to pre-cure the inner side of the sealant. Therefore, after an array substrate and a color substrate are cell-assembled and before an ultraviolet curing is completed, because the inner side of the sealant have been subject to an ultraviolet curing process, and small molecules in the sealant have been cross linked to form macromolecule structure, and macromolecules are hard to be dissolved, the yield rate of products can be improved, and defections such as image retention or light leakage when a liquid crystal panel displays images can be avoided. Moreover, because the inner side of the sealant has been subject to a pre-curing process in cell-assembling, the liquid crystals will not be contaminated even if liquid crystals which are diffused are contacted with the sealant. Therefore, a distance between an edge of a coated liquid crystal pattern and the sealant can be decreased, and liquid crystals can be fully diffused, defections such as incompletely filling and corner bubbles can be reduced.

What have been described above are only specific implementations of the present disclosure, the protection scope of the present disclosure is not limited thereto. Any modifications or substitutions easily occur to those skilled in the art within the technical scope of the present disclosure should be within the protection scope of the present disclosure. Therefore, the protection scope of the present disclosure should be based on the protection scope of the claims.

This application claims the benefit of priority from Chinese patent application No. 201610006868.1 filed on Jan. 4, 2016, the disclosure of which is incorporated herein in its entirety by reference as a part of the present application.

What is claimed is:

1. A sealant coating apparatus comprising a sealant injection head and an ultraviolet lamp, wherein the ultraviolet lamp is at least disposed at a side of the sealant injection head, upon sealant being coated on a substrate with the sealant injection head, the ultraviolet lamp is configured to pre-cure an inner side of the sealant.

2. The sealant coating apparatus according to claim 1, wherein the ultraviolet lamp is a strip-like ultraviolet lamp, and a long axis direction of the strip-like ultraviolet lamp is perpendicular to a main surface of the substrate.

3. The sealant coating apparatus according to claim 1, wherein the ultraviolet lamp comprises a convex lampshade.

4. The sealant coating apparatus according to claim 1, wherein the ultraviolet lamp is disposed at the side of the sealant injection head by a rectangular frame-like lamp hanger.

5. The sealant coating apparatus according to claim 4, wherein the ultraviolet lamp is movable and disposed at a side of the rectangular frame-like lamp hanger.

6. The sealant coating apparatus according to claim 4, wherein at least one ultraviolet lamp is fixed at each side of the rectangular frame-like lamp hanger.

7. The sealant coating apparatus according to claim 1, wherein the ultraviolet lamp comprises a light emitting diode ultraviolet lamp.

8. The sealant coating apparatus according to claim 1, wherein the inner side of the sealant is a side of the sealant close to a centre of the substrate.

9. A sealant coating method comprising:
coating sealant on a substrate with a sealant injection head;
upon the sealant being coated on the substrate, pre-curing an inner side of the sealant with an ultraviolet lamp.

10. The sealant coating method according to claim 9, wherein the inner side of the sealant is 10%-20% of a total volume of the sealant.

11. The sealant coating method according to claim 9, wherein the ultraviolet lamp is disposed at a side of the sealant injection head by a rectangular frame-like lamp hanger to pre-cure the inner side of the sealant.

12. The sealant coating method according to claim 11, wherein the ultraviolet lamp is movable and disposed at any side of the rectangular frame-like lamp hanger, and the ultraviolet lamp is capable of moving with the sealant injection head to pre-cure the inner side of the sealant.

13. The sealant coating method according to claim 11, wherein at least one ultraviolet lamp is fixed at each side of the rectangular frame-like lamp hanger, upon the sealant injection head moving to any side of the rectangular frame-like lamp hanger, the ultraviolet lamp fixed on the side is turned on.

14. The sealant coating method according to claim 9, wherein the ultraviolet lamp comprises a light emitting diode ultraviolet lamp.

15. The sealant coating method according to claim 9, wherein the inner side of the sealant is a side of the sealant close to a centre of the substrate.
